(19) United States
(12) Patent Application Publication
(10) Pub. No.: US 2020/0307102 A1
(43) Pub. Date: Oct. 1, 2020

(54) SYSTEM AND METHOD FOR ADDITIVE MANUFACTURING OF CUSTOM VEHICLES

(71) Applicants: John Swallow, Coeur d'Alene, ID (US); Ryan C. Stockett, Spokane, WA (US)

(72) Inventors: John Swallow, Coeur d'Alene, ID (US); Ryan C. Stockett, Spokane, WA (US)

(21) Appl. No.: 16/831,479

(22) Filed: Mar. 26, 2020

Related U.S. Application Data
(60) Provisional application No. 62/825,012, filed on Mar. 27, 2019.

(51) Int. Cl. B29C 64/393; B33Y 50/02; G05B 19/4097; G06Q 50/04; G06Q 30/06; G06Q 20/08

(52) U.S. Cl. CPC B29C 64/393; B33Y 50/02; G05B 19/4097; G06Q 50/04; G05B 2219/35134; G06Q 30/0643; G06Q 30/0627; G06Q 20/0855; G06Q 30/0621

(57) ABSTRACT

A system is disclosed for use in fabricating a custom vehicle. The system may include an additive manufacturing machine, and at least one computing device operatively connected to the additive manufacturing machine. The at least one computing device includes a memory having computer-executable instructions stored thereon and a processor configured to execute the computer-executable instructions to receive from a user a selection of available components that can be built into the custom vehicle, and to generate a unique model of the custom vehicle based on the selection. The processor is further configured to execute the computer-executable instructions to generate code associated with the unique model, and to direct the code to the additive manufacturing machine, causing the additive manufacturing machine to additively manufacture at least a portion of the custom vehicle.

### RELATED APPLICATION

This application is based on and claims the benefit of priority from U.S. Provisional Application No. 62/825,012 that was filed on Mar. 27, 2019, the contents of which are expressly incorporated herein by reference.

### TECHNICAL FIELD

The present disclosure relates generally to manufacturing systems and methods and, more particularly, to systems and methods for additive manufacturing of custom vehicles.

### BACKGROUND

Vehicles (e.g., cars, trucks, boats, etc.) have traditionally been manufactured in high number, but in a limited number of models. This is because traditional manufacturing relies on tools (e.g., stamps, molds, machining centers, etc.) that are unique to each model and have high costs, which must be spread out over a larger output in order to make the costs of the resulting vehicle palatable to the consumer. Once a vehicle model is discontinued, the tools unique to that model are often discarded. Unfortunately, traditional manufacturing processes limit creativity, increase scarcity of older vehicle models, and reduce the ability to update vehicles with emerging technology.

Vehicle-customizing is a labor-intensive process, whereby vehicle models (particularly older models that are no longer being produced) are modified for appearance and/or performance by highly skilled artists and mechanics. This process typically involves recycling an existing vehicle by manually cutting away unwanted or damaged portions of the vehicle, manually fabricating replacement portions, and/or manually swapping parts between a limited set of similar models. While customized vehicles can be beautiful works of art, the process to create them is generally very expensive and still results in a vehicle having a performance level lower than that of the originally manufactured models.

Additive manufacturing (a.k.a., 3D-printing) is being adopted more heavily in recent times by automotive manufacturers, as a way to create custom parts without the capital investment in unique tools. Additive manufacturing is also being used by vehicle restorers as a way to recreate outdated parts that are no longer available from original equipment manufacturers. Additive manufacturing is a way of making three-dimensional parts by depositing overlapping layers of material (e.g., thermosets, thermoplastics, metals, ceramics, fibers, etc.) under the guided control of a computer. There are many different additive manufacturing technologies, including FDM, CF3D®, SLA, DMLS, SLM, DLP, EBM, BJ, LOM, and others.

While additive manufacturing has been used to fabricate custom parts and to replicate no-longer-available parts, its use and the benefit thereof have been limited. For example, each part to be additively manufactured must be meticulously modeled within expensive CAD software based on existing engineering drawings. The skills required to model the parts is not widespread, and it can be difficult to obtain the necessary engineering drawings. In addition, if custom changes to the parts are then desired, the user must have the engineering skills and knowledge required to make the changes. Further, the time required to find the associated engineering drawings, to model the associated parts, and to print the parts may be too much for most users, especially when large-scale vehicle modifications are desired.

The disclosed systems and methods are directed to overcoming one or more of the problems set forth above and/or other problems of the prior art.

### SUMMARY

In one aspect, the present disclosure is directed to a system for fabricating a custom vehicle. The system may include an additive manufacturing machine, and at least one computing device operatively connected to the additive manufacturing machine. The at least one computing device includes a memory having computer-executable instructions stored thereon and a processor configured to execute the computer-executable instructions to receive from a user a selection of available components that can be built into the custom vehicle, and to generate a unique model of the custom vehicle based on the selection. The processor is further configured to execute the computer-executable instructions to generate code associated with the unique model, and to direct the code to the additive manufacturing machine, causing the additive manufacturing machine to additively manufacture at least a portion of the custom vehicle.

In another aspect, the present disclosure is directed to a method of fabricating a custom vehicle. The method may include receiving from a user a selection of available components that can be built into the custom vehicle, and generating a unique model of the custom vehicle based on the selection. The method may also include generating code associated with the unique model, and directing the code to an additive manufacturing machine, causing the additive manufacturing machine to additively manufacture at least a portion of the custom vehicle

### BRIEF DESCRIPTION OF THE DRAWINGS

FIG. 1 is a diagrammatic illustration of an exemplary disclosed additive manufacturing machine and a corresponding system that may be used to control the machine;

FIG. 2 is a flowchart depicting an exemplary method that may be performed by the system of FIG. 1; and

FIGS. 3-7 are exemplary GUI interfaces that may be generated by and/or shown on the system of FIG. 1.

### DETAILED DESCRIPTION

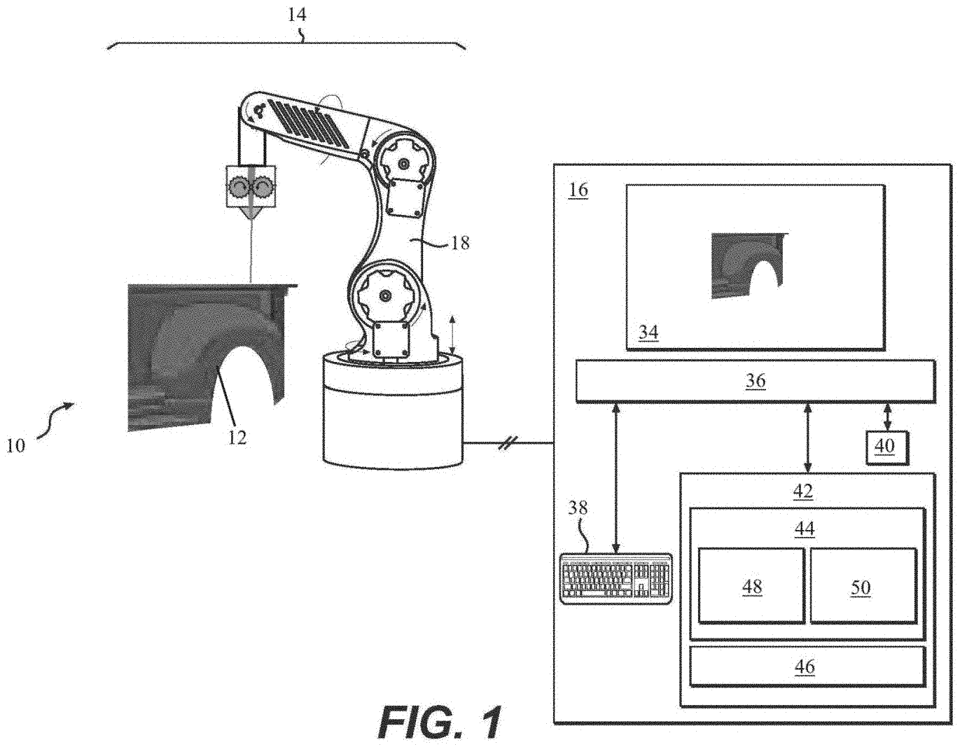

FIG. 1 illustrates an exemplary control system (“system”) 10, which may be used to design, customize, and/or fabricate a vehicle part (“part”) 12. System 10 may include, among other things, an additive manufacturing machine (“machine”) 14 and at least one computing device 16 that is operatively connected to machine 14. Machine 14 may be configured to create part 12 under the guided control of computing device 16, for example by way of an additive manufacturing process. Any known additive manufacturing process be utilized for this purpose and benefit from the disclosed control systems and methods.

Machine 14 may be comprised of components that are controllable to create part 12, layer-by-layer and/or in free space (e.g., without the bracing of an underlying layer). These components may include, among other things, a support 18 and any number of discharging units (e.g., print heads) 20 coupled to and/or powered via support 18. In the disclosed embodiment of FIG. 1, support 18 is a robotic arm capable of moving unit 20 in multiple directions during fabrication of part 12. It should be noted, however, that any other type of support (e.g., an overhead gantry, an arm/gantry combination, a submersible elevator and/or print platform, etc.) capable of moving unit 20 in the same or in a different manner could also be utilized, if desired. It is also contemplated that multiple supports 18 could be cooperatively controlled by computing device 16 to move any number of units 20 during simultaneous fabrication of the same part 12.

Each unit 20 (only one shown in FIG. 1, for clarity) may be configured to discharge, sinter, coalesce, or otherwise bind together material at precise coordinates to build up part 12. In the disclosed embodiment of FIG. 1, unit 20 is a material extrusion and/or pultrusion machine, which discharges a melted thermoplastic, a liquid thermoset, solid filament, a powdered metal, a ceramic slurry, a fiber (e.g., short fiber, long fiber, and/or continuous fiber) reinforced resin, or another material known in the art during predefined movements induced by support 18. The deposited material may be cooled, heated, chemically cured, sintered, baked, or otherwise hardened, such that part 12 maintains or achieves a desired size, shape, and material properties. It is also contemplated that unit 20 could embody another type of additive machine (e.g., a sintering-type machine, a vat photo-polymerization machine, a material jetting machine, a binder jetting machine, a directed energy deposition machine, or another machine), if desired.

Any number of separate computing devices 16 may be used to design and/or control material placement within and/or curing/hardening of the materials that make up part 12. Computing device 16 may include, among other things, a display 34, one or more processors 36, any number of input/output (“I/O”) devices 38, any number of peripherals 40, and one or more memories 42 for storing programs 44 and data 46. Programs 44 may include, for example, any number of design and/or printing apps 48 and an operating system 50.

Display 34 of computing device 16 may include a liquid crystal display (LCD), a light emitting diode (LED) screen, an organic light emitting diode (OLED) screen, and/or another known display device. Display 34 may be used for presentation of data (e.g., vehicle selection options, vehicle design options, associated costs, fabrication status, etc.) under the control of processor 36.

Processor 36 may be a single or multi-core processor configured with virtual processing technologies, and use logic to simultaneously execute and control any number of operations. Processor 36 may be configured to implement virtual machine or other known technologies to execute, control, run, manipulate, and store any number of software modules, applications, programs, etc. In addition, in some embodiments, processor 36 may include one or more specialized hardware, software, and/or firmware modules (not shown) specially configured with particular circuitry, instructions, algorithms, and/or data to perform functions of the disclosed methods. It is appreciated that other types of processor arrangements could be implemented that provide for the capabilities disclosed herein.

Memory 42 can be a volatile or non-volatile, magnetic, semiconductor, tape, optical, removable, non-removable, or other type of storage device or tangible and/or non-transitory computer-readable medium that stores one or more executable programs 44, such as design and/or printing apps 48 and operating system 50. Common forms of non-transitory media include, for example, a flash drive, a flexible disk, a hard disk, a solid state drive, magnetic tape or other magnetic data storage medium, a CD-ROM or other optical data storage medium, any physical medium with patterns of holes, a RAM, a PROM, an EPROM, a FLASH-EPROM or other flash memory, NVRAM, a cache, a register or other memory chip or cartridge, and networked versions of the same.

Memory 42 may store instructions that enable processor 36 to execute one or more applications, such as design and/or fabrication apps 48, operating system 50, and any other type of application or software known to be available on computer systems. Alternatively or additionally, the instructions, application programs, etc. can be stored in an internal and/or external database (e.g., a cloud storage system—not shown) that is in direct communication with computing device 16, such as one or more databases or memories accessible via one or more networks (not shown). Memory 42 can include one or more memory devices that store data and instructions used to perform one or more features of the disclosed embodiments. Memory 42 can also include any combination of one or more databases controlled by memory controller devices (e.g., servers, etc.) or software, such as document management systems, Microsoft SQL databases, SharePoint databases, Oracle™ databases, Sybase™ databases, or other relational databases.

In some embodiments, computing device 16 is communicatively connected to one or more remote memory devices (e.g., remote databases—not shown) through a network (not shown). The remote memory devices can be configured to store information that computing device 16 can access and/or manage. By way of example, the remote memory devices could be document management systems, Microsoft SQL database, SharePoint databases, Oracle™ databases, Sybase™ databases, Cassandra, HBase, or other relational or non-relational databases or regular files. Systems and methods consistent with disclosed embodiments, however, are not limited to separate databases or even to the use of a database.

Programs 44 may include one or more software and/or firmware modules causing processor 36 to perform one or more functions of the disclosed embodiments. Moreover, processor 36 can execute one or more programs located remotely from computing device 16. For example, computing device 16 can access one or more remote programs that, when executed, perform functions related to disclosed embodiments. In some embodiments, programs 44 stored in memory 42 and executed by processor 36 can include one or more of design and/or fabrication apps 48 and operating system 50. Apps 48 may cause processor 36 to perform one or more functions of the disclosed methods.

Operating system 50 may perform known operating system functions when executed by one or more processors such as processor 36. By way of example, operating system 50 may include Microsoft Windows™, Unix™, Linux™, OSX™, and IOS™ operating systems, Android™operating systems, or another type of operating system 50. Accordingly, disclosed embodiments can operate and function with computer systems running any type of operating system 50.

I/O devices 38 may include one or more interfaces for receiving signals or input from a user and/or machine 14, and for providing signals or output to machine 14 that allow part 12 to be printed. For example, computing device 16 can include interface components for interfacing with one or more input devices, such as one or more keyboards, mouse devices, and the like, which enable computing device 16 to receive input from a user.

Peripheral device(s) 40 may be standalone devices or devices that are embedded within or otherwise associated with machine 14 and used during fabrication of part 12. Peripherals 40 can embody input devices (e.g., laser and/or point cloud scanners, cameras, desktop scanners, and other similar devices known in the art for capturing the size and/or shape of an existing part 12) and/or output devices (e.g., one or more actuators, such as a material feeders, curing/hardening energy generators, positioning motors, cutting devices, material guides, mixers, compactors, sanders, painters, finishers, etc.). In some embodiments, peripherals 40 may, themselves, include one or more processors, a memory, and/or a transceiver. When peripheral device(s) 40 are equipped with a dedicated processor and memory, the dedicated processor may be configured to execute instructions stored on the memory to receive commands from processor 36 associated with video, audio, other sensory data, control data, location data, material processing data, etc., including capture commands, processing commands, motion commands, machining commands, and/or transmission commands The transceiver may include a wired or wireless communication device capable of transmitting data to or from one or more other components in system 10. In some embodiments, the transceiver can receive data from processor 36, including instructions for sensor and/or actuator activation and for the transmission of data via the transceiver. In response to the received instructions, the transceiver can packetize and transmit data between processor 36 and the other components.

Design and/or fabrication apps 48 may cause computing device 16 to perform methods related to generating, receiving, processing, analyzing, storing, and/or transmitting data in association with operation of machine 14 and corresponding design and fabrication of part 12. For example, apps 48 may be able to configure computing device 16 to perform operations including: showing a graphical user interface (GUI) on display 34 for receiving design/control instructions and information from the operator of machine 14; capturing data associated with machine 14 (e.g., existing part data via peripherals 40); receiving instructions via I/O devices 38 and/or the user interface regarding specifications, desired characteristics, and/or desired performance of part 12; processing the control instructions; generating one or more possible designs of and/or plans for fabricating part 12; providing recommendations of one or more designs and/or plans; controlling machine 14 to fabricate a recommended and/or selected design via a recommended and/or selected plan; analyzing the fabrication; and/or providing feedback and adjustments to machine 14 for improving future fabrications.

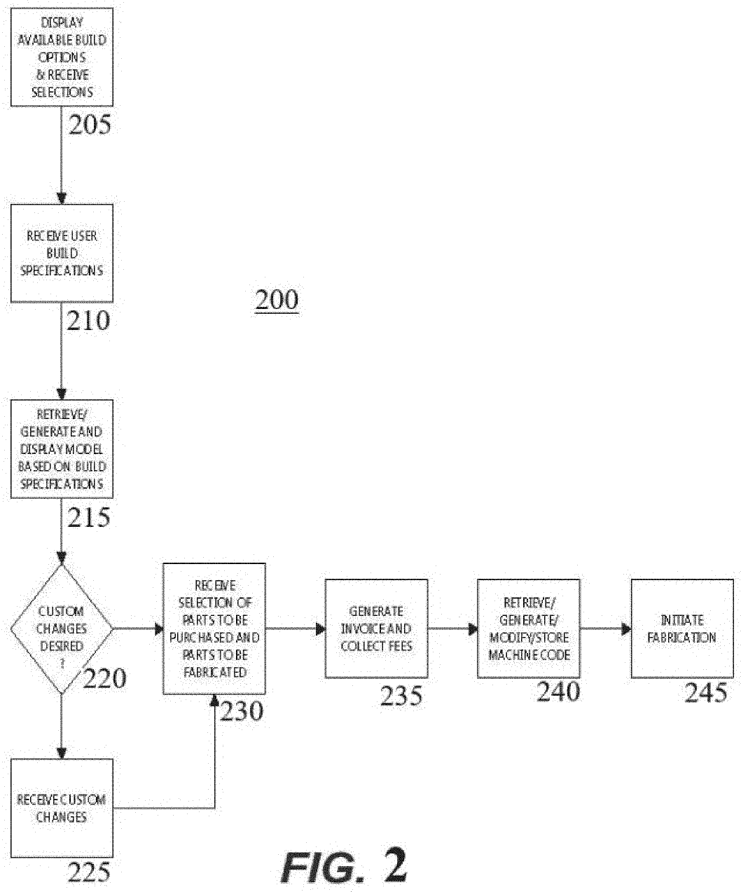

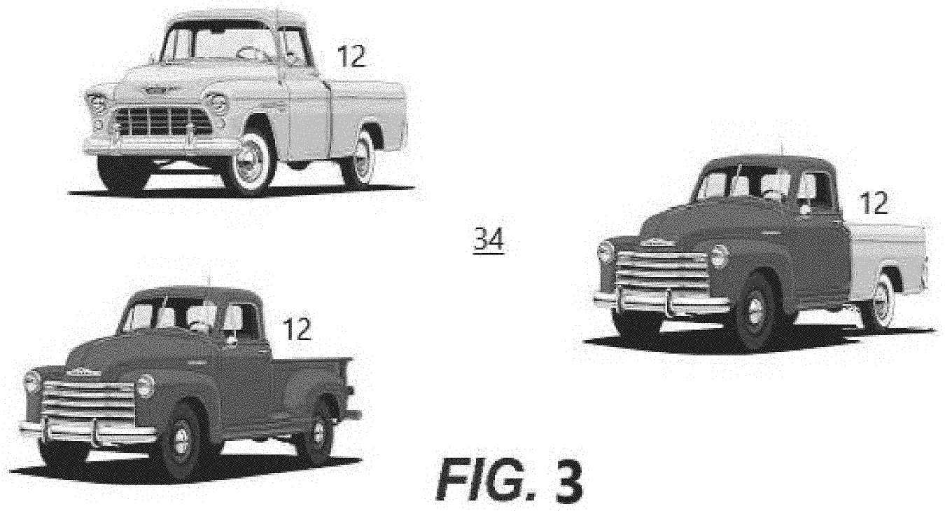

FIG. 2 is a flowchart depicting an exemplary method 200 that may be implemented by computing device 16 during design and/or fabrication of part 12 by machine 14. FIGS. 3-7 represent various steps in method 200 of FIG. 2. FIGS. 2-7 will be discussed in detail in the following section to further illustrate the disclosed concepts.

### INDUSTRIAL APPLICABILLITY

The disclosed systems may be used to design and fabricate custom vehicles and custom vehicle parts, based on existing models and/or existing parts. The system may allow for re-creation of outdated models that are no longer available, combinations of features from multiple models, and other custom changes, as selected and/or specified by a user. Operation of system 10 will now be described in detail, with reference to FIGS. 2-7.

As can be seen in the flowchart of FIG. 2, the creation of part 12 may generally begin with the display of different available build options (Step 205). These options may be presented graphically and/or as lists by processor 36 via the GUI shown on display 34 (referring to FIG. 1). For example, the user may be allowed to select a make of an existing vehicle that the user wishes to re-create in whole and/or from which only a portion is to be re-created. The user may also select a model, a year, and/or a trim of the vehicle. It should be noted that the user may select multiple makes, models, years, and/or trims, if portions of multiple vehicles are to be re-created and/or combined.

For example, referring to FIG. 3, the user may be able to select (e.g., via any combination of pulldown menus, lists, radio buttons, input windows, etc.) Chevrolet as the make, the 3100 series truck as the model (upper left), and 1955 as the year. The user may then indicate that the entire vehicle is to be fabricated and assembled or that only a chassis, a body kit, an interior, or a single component (e.g., a fender or a dashboard) is to be fabricated.

Alternatively, the user may select the '55-3100 series truck, as well as the Chevrolet Advance-Design truck from 1947 (lower left of FIG. 3). The user may then make a selection that an entire vehicle (far right of FIG. 3) is to be fabricated using only a portion of the first vehicle (e.g., the '47 chassis, powertrain, and front end) and a remaining portion of the second vehicle (e.g., the '55 rear body).

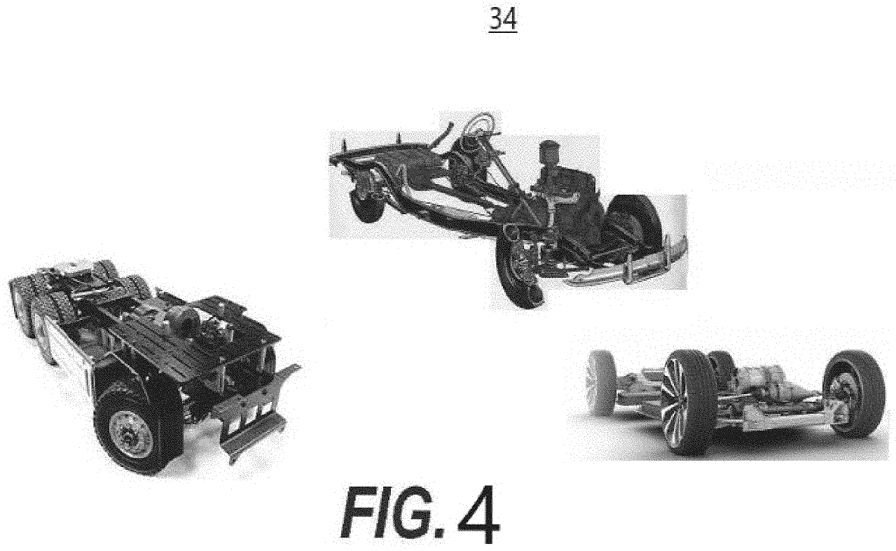

In another example, the user may be able to select a body of a first make, model, and year (e.g., via the GUI of FIG. 3) separate from a rolling chassis (e.g., a chassis/powertrain assembly—see FIG. 4) that relates to the body selection or that is completely unrelated. For instance, the user may select from an existing 10-wheel modern diesel rolling chassis (far left of FIG. 4), a four-wheel age-similar gasoline rolling chassis (center of FIG. 4), or a modern all-electric rolling chassis (far right of FIG. 4). Other and/or different options of rolling chassis may be available.

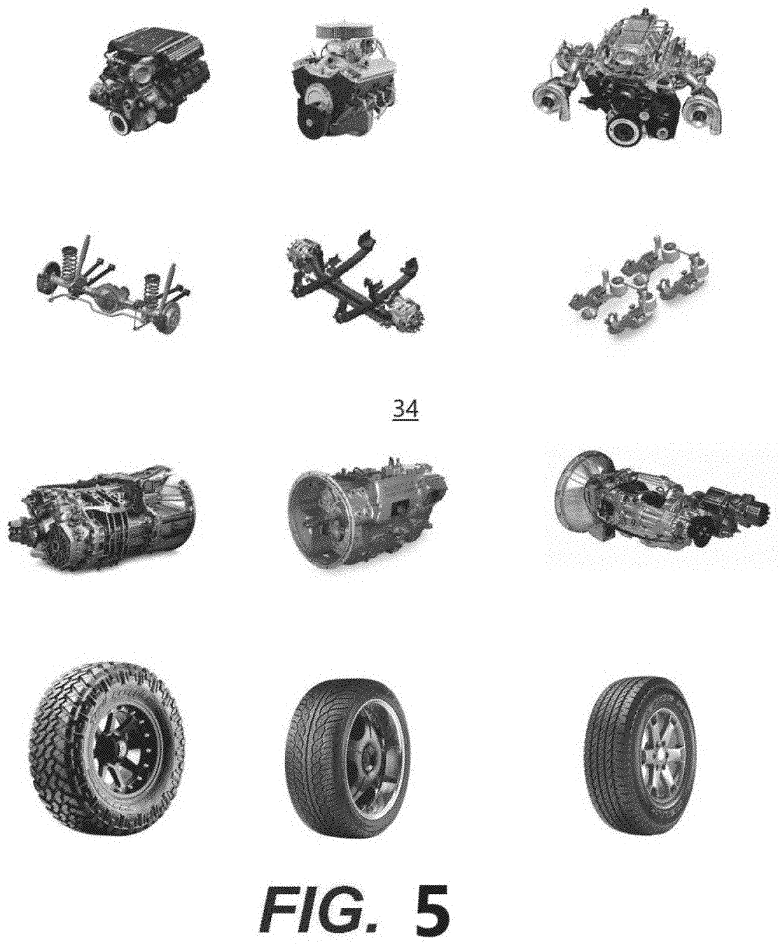

In yet another example, the user may be able to make the body selection, as well as select specific components to include within the rolling chassis (See FIG. 5). For instance, the user may be able to select a particular and/or displayed power plant (e.g., a modern diesel engine, an age-appropriate naturally aspirated gasoline engine, an enhanced turbocharged engine, an electric motor, or a hybrid power plant), a particular transmission (e.g., a modern 10-speed automatic transmission, an age-appropriate manual transmission, a hybrid electric/hydraulic transmission, etc.), a particular suspension arrangement (e.g., coil springs, leaf springs, air bags, hydraulic dampers, control arms, etc.), and/or particular wheels (e.g., number of axles, tires per axle, types and/or sizes of tires, etc.).

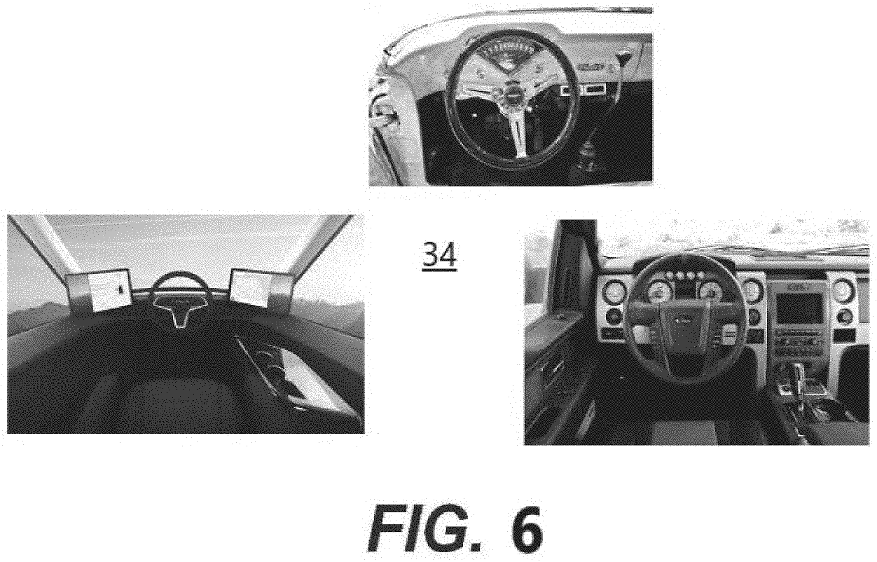

In one embodiment, in addition to the user selecting a vehicle, a body, and/or a rolling chassis, the user may also be able to select from a collection of available interior configurations. For example, the user may be able to select an interior (e.g., dashboard, console, seating arrangement, steering wheel, head liner, floor liner, etc.) that corresponds with the selected vehicle and/or body (see center of FIG. 6), an interior of another specific vehicle (see far right of FIG. 6), or a modern interior that isn't necessarily associated with any existing vehicle (see far left of FIG. 6).

It is contemplated that the user may make only the selection of a particular body style, in some circumstances, and thereafter specify certain criteria (e.g., size, shape, performance, etc.) for the remainder of vehicle 12 (Step 210). For example, the user may select a width, a length, a torque, an acceleration, a top speed, a braking capacity, a fuel efficiency, a fuel type, a seating capacity, a number and/or types of gauges, a level of automation, a comfort level, a ground clearance, a cargo volume, etc.).

Based on the selections made by the user at Steps 205 and 210, processor 36 may be configured to retrieve and/or generate and show on display 34 a corresponding vehicle model (Step 215—see, for example, right side of FIG. 3). In the simplest application, processor 36 may have stored in memory one or more existing models of the '55-3100 series truck and simply retrieve these models from memory for display 34. The models may include some OEM components (e.g., entire rolling chassis or chassis frame, power plant, transmission, suspension, wheels, seats, etc.) and some components to be fabricated by machine 14 (e.g., chassis frame, body frame, body panel(s), dashboard, etc.). Multiple models for each vehicle may exist, wherein the models have differing combinations of OEM components, fabricated components, and material options (e.g., steel, aluminum, carbon fiber, plastic, etc.) within the OEM and/or fabricated components. As will be discussed in further detail below, each time a new model is created (e.g., based on user-customization) by processor 36, that model may be stored within memory 42 for future use as an available selection for a new user.

Processor 36 may generate a new vehicle model by virtually assembling models of existing subassemblies (e.g., rolling chassis, bodies, interiors, etc.) and/or existing components. In some instances, the subassemblies and components may have data-defined space constraints (e.g., size, shape, volume, etc.) and/or mounting features (e.g., bolt patterns, flange locations, tab features, bearing and/or gear connections, etc.) that allow bolt-together assembly without modification. For instance, an existing body frame of a '56-3100 series truck might be able to mount directly to a '55-3100 series truck's rolling chassis, without modification required of either the body frame or rolling chassis.

In other instances, however, a spatial constraint and/or a mounting feature mismatch may inhibit the virtual assembly. Processor 36 may be configured to determine when modifications are required to facilitate the desired assembly, and to automatically implement the modifications within one or more of the associated virtual models. For example, the associated models may be virtually overlaid following a common form of general alignment (e.g., aligned coordinate origins, aligned axes, aligned planes of symmetry, and/or other metadata). Processor 36 may then analyze the assembly to determine the existence of geometry from multiple models within the same space and/or the matchup of predefined and related mounting features.

When an interference exists (e.g., when geometry from overlaid models exists within the same space) and/or when the predefined and related mounting features do not properly match up (e.g., when a gap exists, when axis are misaligned, when the features are not copasetic, etc.), processor 36 may automatically make adjustments to one or more of the models. It is contemplated that, in some embodiments, processor 36 may also or alternatively generate a flag, letting the user know of the interference and/or mismatch and allowing the user an opportunity to make the adjustments manually, if desired.

Processor 36 may be configured to make the model adjustments in different ways. For example, processor 36 may be configured to push, pull, stretch, add to, and/or subtract from the geometry of one or more of the models. The particular model(s) adjusted by processor 36 may be chosen for adjustment in a number of different ways. For example, processor 36 may select to make the required adjustment within as few models as possible, thereby reducing the number of unique models that are created thereby. Alternatively or additionally, processor 36 may select to make the adjustments only within models that provide aesthetic qualities as opposed to models that provide structural qualities and/or might require certification by a governing body prior to use. Similarly, if multiple models must be adjusted, processor 36 may select to make the adjustments first within models having little or no effect on aesthetics, structure, or performance, followed by changes in the aesthetic-related models, followed by changes in the structural-related models, followed last by changes within certification-requiring models. Alternatively, processor 36 may select to make adjustments sooner and/or to make larger adjustments within models that are smaller, simpler, cheaper, or more common. Other hierarchies of decision making may also be implemented.

Processor 36 may choose to push a model boundary, pull a boundary, stretch a feature, shrink a feature, or otherwise change model geometry in a manner that decreases the associated interference and/or increases a match between mating/connecting component features. For example, based on a known center of mass location of the associated models, processor 36 may make adjustments that move the features more towards their centers and/or more away from the location of interference. Alternatively, processor 36 may calculate an amount of interference and/or mismatch, make an adjustment, and recalculate the interference and/or mismatch to determine if the interference and/or mismatch was reduced. Other ways to determine what adjustments to make may also be implemented. In some embodiments, a smoothing algorithm may be implemented by processor 36 after making the required adjustments, such that the adjustments do not result in sudden geometric changes that significantly change the overall appearance or performance of part 12.

In another example, processor 36 may be configured to generate a new model for an intermediate part that functions to connect mismatching existing models. For example, rather than pushing, pulling stretching, etc., processor 36 may leave the existing models unchanged and, instead generate a model for a spacer or adapter that connects to the existing models and binds them together. Processor 36 may do this, for example, by defining surfaces of the new model that are mirror images to engagement surfaces of the existing models, and then filling a swept volume between the surfaces.

When specifications (e.g., performance and/or capacity specifications) made by the user at Step 210 require a unique assembly of components (e.g., OEM and/or custom components), processor 36 may be configured to select these components based on predefined compatibility and/or performance rating of each component. For example, a particular power plant may be compatible with only a subset of available transmissions. Likewise, particular wheels may only be used with particular suspensions. Similarly, particular power plant/transmission configurations may provide certain levels of acceleration, while certain braking system/suspensions may provide certain levels of deceleration. And space constraints, weights, support requirements, etc. for each component may be known and tallied for any selected arrangement. This information may be associated with each component and/or component pairing and stored within memory 42 for use by processor 36. For example, processor 36 may use this information to determine needed changes to existing and/or to generate models for new chassis frames, body frames, and/or body panels.

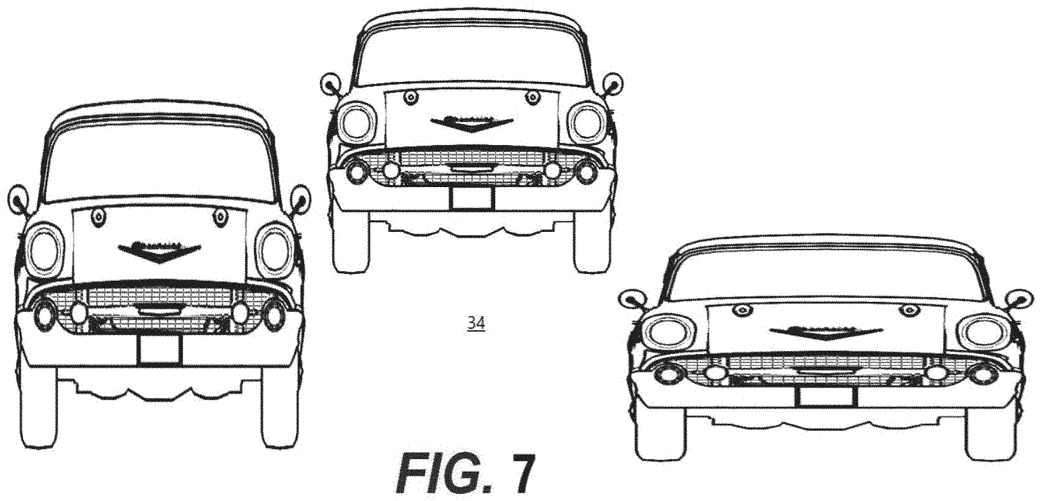

As described above, in reference to Step 215, after processor 36 retrieves and/or generates the new model and/or assembly, processor may show on display 34 the corresponding model and/or assembly (see FIG. 7). The user may then be able to customize the model and/or assembly. Processor 36 may determine if customization is desired (Step 220), and responsively receive the customization(s) from the user via I/O devices 38. For example, the user may be able to lift (see left side of FIG. 7), lower (see middle of FIG. 7), stretch (see right side of FIG. 7), or otherwise make adjustments to the overall size, shape, stance, etc. of the depicted model. Likewise, the user may be able to swap out automatically-selected components for manually-selected components, change materials used in fabrication of the components (e.g., from steel to aluminum or carbon), adjust color schemes, merge normally separate components and remove seams (e.g., instead of separate body frame and fender, merge to unibody design), or otherwise make changes to the depicted model.

Processor 36 may receive these custom changes (Step 225), generate a list of all components in the model, and then receive a selection of which of the components the customer would like to purchase, have fabricated, and/or have assembled (Step 230). In particular, the various components (e.g., just a fender) of the model can be fabricated, sold individually, packaged together (e.g., as a body kit), sub-assembled, fully assembled, and/or completely finished. Depending on the selection made at Step 230, processor 36 may generate an invoice for the associated parts 12 and services, and electronically collect the associated fees (Step 235).

After confirmation of fee-collection, processor 36 may retrieve, generate, modify, and/or store machine code associated with the fabricated parts 12. This code may take any form known in the art, and be directed to machine 14. The code may cause support 18 to move unit 20 and cause unit 20 to discharge and/or otherwise harden corresponding material at particular coordinates associated with the displayed model(s) (Step 240).

It should be noted that machine 14 may fabricate parts 12 that may be used during subsequent assembly, or fabricate parts 12 as part of the assembly process. For example, it may be possible for machine 14 to fabricate a body frame and/or panels directly onto a rolling chassis. Likewise, it may be possible for machine 14 to fabricate a dashboard and/or seat supports directly into a body frame.

It will be apparent to those skilled in the art that various modifications and variations can be made to the disclosed systems and methods. Other embodiments will be apparent to those skilled in the art from consideration of the specification and practice of the disclosed systems and methods. It is intended that the specification and examples be considered as exemplary only, with a true scope being indicated by the following claims and their equivalents.

What is claimed is:

1. A system for fabricating a custom vehicle, comprising:
an additive manufacturing machine; and
at least one computing device operatively connected to the additive manufacturing machine, the at least one computing device including a memory having computer-executable instructions stored thereon and a processor configured to execute the computer-executable instructions to:
receive from a user a selection of available components that can be built into the custom vehicle;
generate a unique model of the custom vehicle based on the selection;
generate code associated with the unique model; and
direct the code to the additive manufacturing machine, causing the additive manufacturing machine to additively manufacture at least a portion of the custom vehicle.

2. The system of claim 1, further including a display, wherein the processor is further configured to execute the computer-executable instructions to cause the available components that can be built into the custom vehicle to be shown on the display.

3. The system of claim 2, wherein:
the processor is further configured to execute the computer-executable instructions to receive from the user specifications for the custom vehicle; and
the unique model of the custom vehicle is generated based at least partially on the specifications.

4. The system of claim 3, wherein the processor is configured to execute the computer-executable instructions to cause the available components that can be built into the custom vehicle to be shown on the display based on the specifications.

5. The system of claim 4, wherein the specifications include identification parameters of an existing vehicle.

6. The system of claim 4, wherein the specifications includes performance parameters to be achieved by the custom vehicle.

7. The system of claim 4, wherein the specifications include a type of the custom vehicle being one of a boat, a car, and a truck.

8. The system of claim 1, further including a display, wherein the processor is further configured to execute the computer-executable instructions to:
cause the unique model of the custom vehicle to be shown on the display;
receive changes to the unique model from the user; and
update the unique model based on the changes.

9. The system of claim 8, wherein the changes to the unique model include at least one of stretching the unique model, shrinking the unique model, and eliminating seams from the unique model.

10. The system of claim 1, wherein the processor is further configured to execute the computer-executable instructions to:
receive from the user a selection of at least one part of the unique model to be fabricated; and
generate and direct code to the additive manufacturing machine associated with only the at last one part of the unique model.

11. The system of claim 1, wherein the processor is further configured to execute the computer-executable instructions to:
determine a fee associated with fabrication of the custom vehicle; and
direct the code to the additive manufacturing machine only after the fee has been received from the user.

12. The system of claim 1, wherein:
the selection of available components includes a power train component; and
the unique model includes a body of the custom vehicle.

13. The system of claim 1, wherein the selection of available components includes a first component from a first existing vehicle, and a second component from a second existing vehicle.

14. The system of claim 1, wherein:
the selection of available components includes an interior configuration; and
the unique model includes an exterior of the custom vehicle.

15. A method of fabricating a custom vehicle, comprising:
receiving from a user a selection of available components that can be built into the custom vehicle;
generating a unique model of the custom vehicle based on the selection;
generating code associated with the unique model; and
directing the code to an additive manufacturing machine, causing the additive manufacturing machine to additively manufacture at least a portion of the custom vehicle.

16. The method of claim 1, further including receiving from the user specifications for the custom vehicle, wherein generating the unique model includes generating the unique model based at least partially on the specifications.

17. The method of claim 16, further including selectively showing on a display the available components that can be built into the custom vehicle based on the specifications.

18. The method of claim 17, wherein the specifications include at least one of identification parameters of an existing vehicle, performance parameters to be achieved by the custom vehicle, a type of the custom vehicle being one of a boat, a car, and a truck.

19. The method of claim 15, further including:
causing the unique model of the custom vehicle to be shown on a display;
receiving changes to the unique model from the user; and
updating the unique model based on the changes.

20. The method of claim 19, wherein the changes to the unique model include at least one of stretching the unique model, shrinking the unique model, and eliminating seams from the unique model.
